(19) United States
(12) Patent Application Publication
(10) Pub. No.: US 2008/0183537 A1
(43) Pub. Date: Jul. 31, 2008

(54) APPROACH TO COMPREHENSIVE REQUIREMENTS SPECIFICATIONS FOR COMPLEX WORKFLOWS

(75) Inventors: Matthew J. Bangel, Poughkeepsie, NY (US); Adam P. Brennand, Worthing (GB); Amy S. Heard, Hilsea (GB); James A. Martin, Endicott, NY (US); Megan Morrison-Chapman, Waterlooville (GB)

Correspondence Address: HOFFMAN WARNICK LLC, 75 STATE ST, 14TH FLOOR, ALBANY, NY, 12207, US

(73) Assignee: INTERNATIONAL BUSINESS MACHINES CORPORATION, Armonk, NY (US)

(21) Appl. No.: 11/668,798

(22) Filed: Jan. 30, 2007

(51) Int. Cl. G06F 9/46

(52) U.S. Cl. 705/8

(57) ABSTRACT

Aspects of the present invention provide a solution for creating a workflow that defines a business process. Specifically, an embodiment of the present invention provides a way for a user to gather overall goals of the business process and to use these goals to define a plurality of stages that represent subsets of the overall business process. For at least one of the stages, the user lists a plurality of activities that are included in the stage as well as the flow among activities in the stage. Each activity in the stage includes operational details that define the process of the activity. The operational details may include preliminary actions, prerequisite conditions and results.

### FIELD OF THE INVENTION

Aspects of the present invention generally relate to generation of workflows. Specifically, aspects of the present invention provide a solution for more efficiently generating workflows for complex business processes.

### BACKGROUND OF THE INVENTION

In the business world of today, it is important that business processes be performed correctly and in a timely manner. Because of this, workflows have been developed to facilitate the process. A workflow is a group of activities that is necessary to perform a particular business process. Workflows help ensure that the requirements of a particular business process are met, as well as providing a model for performing the business process in the case that the business process needs to be performed again at a later time.

However, as a business process becomes more complex, generation of workflows that define all of the activities in the business process become prohibitively difficult to generate. That is, a workflow that concentrates on high-level goals, and thus includes few activity steps may not have the detail that is required to successfully complete the activity. In contrast, a workflow that has the detail that is required to successfully complete an activity may need to contain so many different activities that it becomes untenable.

In view of the foregoing, there exists a need for a solution that overcomes one or more of the shortcomings of the prior art.

### SUMMARY OF THE INVENTION

In general, aspects of the present invention provide a solution for creating a workflow that defines a business process. Specifically, an embodiment of the present invention provides a way for a user to gather overall goals of the business process and to use these goals to define a plurality of stages that represent subsets of the overall business process. For at least one of the stages, the user lists a plurality of activities that are included in the stage as well as the flow among activities in the stage. Each activity in the stage includes operational details that define the process of the activity. The operational details may include preliminary actions, prerequisite conditions and results.

A first aspect of the present invention provides a method for creating a workflow that defines a business process, comprising: defining a plurality of stages, at least one stage of the plurality of stages comprising a plurality of activities that are logically related; listing, for the stage, the activities that comprise the stage and the flow between the activities, and defining, for each activity of the activities, a set of operational details that the activity includes.

A second aspect of the present invention provides a system for creating a workflow that defines a business process, comprising: a stage definer for defining a plurality of stages, at least one stage of the plurality of stages comprising a plurality of activities that are logically related; a stage activity lister for listing, for the stage, the activities that comprise the stage and the flow between the activities, and an operational detail definer for defining, for each activity of the activities, a set of operational details that the activity includes.

A third aspect of the present invention provides a program product stored on a computer readable medium for creating a workflow that defines a business process, the computer readable medium comprising: program code for defining a plurality of stages, at least one stage of the plurality of stages comprising a plurality of activities that are logically related; program code for listing, for the stage, the activities that comprise the stage and the flow between the activities, and program code for defining, for each activity of the activities, a set of operational details that the activity includes.

A fourth aspect of the present invention provides a method for deploying a system for creating a workflow that defines a business process, comprising: providing a computer infrastructure being operable to: define a plurality of stages, at least one stage of the plurality of stages comprising a plurality of activities that are logically related; list, for the stage, the activities that comprise the stage and the flow between the activities, and define, for each activity of the activities, a set of operational details that the activity includes.

A fifth aspect of the present invention provides computer software embodied in a propagated signal for creating a workflow that defines a business process, the computer software comprising instructions for causing a computer system to perform the following: define a plurality of stages, at least one stage of the plurality of stages comprising a plurality of activities that are logically related; list, for the stage, the activities that comprise the stage and the flow between the activities, and define, for each activity of the activities, a set of operational details that the activity includes.

A sixth aspect of the present invention provides a method for creating a workflow that defines a business process, the method comprising managing a computer infrastructure that performs the process described herein; and receiving payment based on the managing.

Therefore, the present invention provides a method, system, and program product for creating a workflow that defines a business process.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows an illustrative computer infrastructure for creating a workflow that defines a business process according to an embodiment of the present invention.

FIG. 2 shows an example of a plurality of stages and a listing of activities for one of the stages according to one embodiment of the present invention.

FIG. 3 shows a plurality of activities having operational details according to one embodiment of the claimed invention.

FIG. 4 shows an illustrative method flow diagram according to one embodiment of the present invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, aspects of the present invention provide a solution for creating a workflow that defines a business process. Specifically, an embodiment of the present invention provides a way for a user to gather overall goals of the business process and to use these goals to define a plurality of stages that represent subsets of the overall business process. For at least one of the stages, the user lists a plurality of activities that are included in the stage as well as the flow among activities in the stage. Each activity in the stage includes operational details that define the process of the activity. The operational details may include preliminary actions, prerequisite conditions and results.

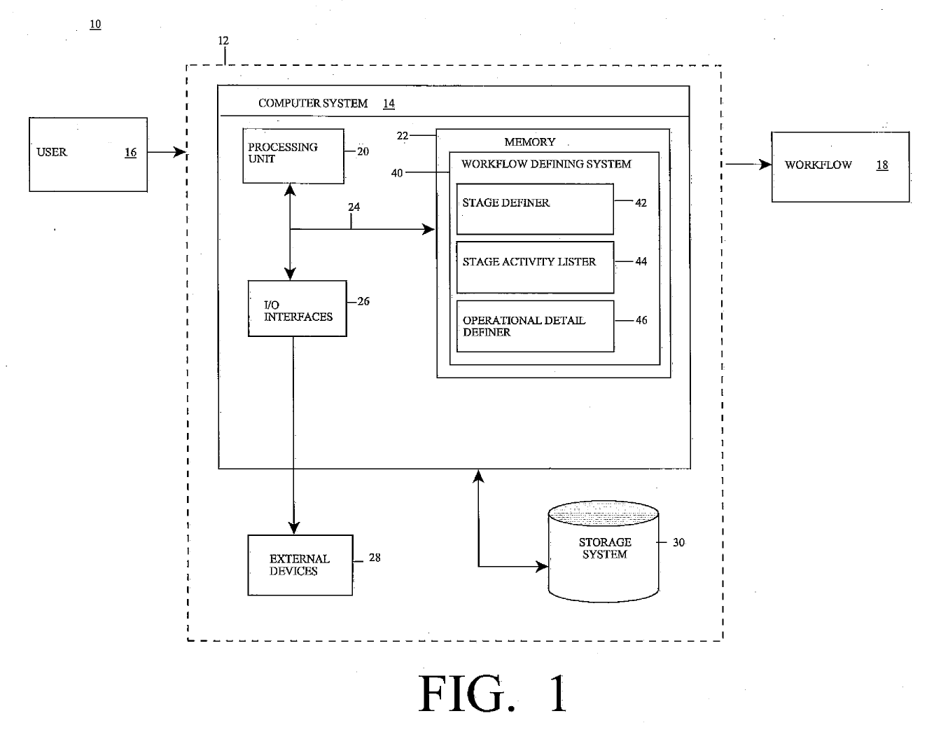

Referring now to FIG. 1, a system 10 for creating a workflow that defines a business process according to an embodiment of the present invention is shown. Specifically, FIG. 1 depicts a system 10 in which a workflow 18 having stages, activities within the stages and operational details within the activities can be created, managed, and/or revised, such as by a user 16. In this way, workflow 18 may be used to define a business process that is complex, i.e., one that has many activities, conditions, flows, and/or operational details, although it should be understood that a simple workflow may also created using aspects of the present invention.

As depicted, system 10 includes a computer system 14 deployed within a computer infrastructure 12. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by a conventional TCP/IP sockets-based protocol, and an Internet service provider could be used to establish connectivity to the Internet. Still yet, computer infrastructure 12 is intended to demonstrate that some or all of the components of system 10 could be deployed, managed, serviced, etc. by a service provider who offers to for create a workflow that defines a business process.

As shown, computer system 14 includes a processing unit 20, a memory 22, a bus 24, and input/output (I/O) interfaces 26. Further, computer system 14 is shown in communication with external I/O devices/resources 28 and storage system 30. In general, processing unit 20 executes computer program code, such as a workflow defining 40, which is stored in memory 22 and/or storage system 30. While executing computer program code, processing unit 20 can read and/or write data to/from memory 22, storage system 30, and/or I/O interfaces 26. Bus 24 provides a communication link between each of the components in computer system 14. External devices 28 can comprise any devices (e.g., keyboard, pointing device, display, etc.) that enable a user to interact with computer system 14 and/or any devices (e.g., network card, modem, etc.) that enable computer system 14 to communicate with one or more other computing devices.

Computer infrastructure 12 is only illustrative of various types of computer infrastructures for implementing the invention. For example, in one embodiment, computer infrastructure 12 comprises two or more computing devices (e.g., a server cluster) that communicate over a network to perform the process of the invention. Moreover, computer system 14 is only representative of various possible computer systems that can include numerous combinations of hardware and/or software. To this extent, in other embodiments, computer system 14 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 20 may comprise a single processing unit, or be distributed across one or more processing units in one or more locations, e.g., on a client and server. Similarly, memory 22 and/or storage system 30 can comprise any combination of various types of data storage and/or transmission media that reside at one or more physical locations. Further, I/O interfaces 26 can comprise any system for exchanging information with one or more external devices 28. Still further, it is understood that one or more additional components (e.g., system software, math co-processing unit, etc.) not shown in FIG. 1 can be included in computer system 14. However, if computer system 14 comprises a handheld device or the like, it is understood that one or more external devices 28 (e.g., a display) and/or storage system(s) 30 could be contained within computer system 14, not externally as shown.

Storage system 30 can be any type of system (e.g., a database) capable of providing storage for information under the present invention. For example, storage system 30 may be used to store parts of or the entirety of workflow 18 during and/or after creation. In addition, storage system 30 may be used to store information used to create workflow 18. To this extent, storage system 30 could include one or more storage devices, such as a magnetic disk drive or an optical disk drive. In another embodiment, storage system 30 includes data distributed across, for example, a local area network (LAN), wide area network (WAN) or a storage area network (SAN) (not shown). Although not shown, additional components, such as cache memory, communication systems, system software, etc., may be incorporated into computer system 14.

Shown in memory 22 of computer system 14 is a workflow defining system 40, which is a software program that provides the functions of the present invention. Workflow defining system 40 provides a system for creating a workflow that defines a business process. To this extent, workflow defining system 40 includes a stage definer 42, a stage activity lister 44, and an operational detail definer 46.

Stage definer 42 defines a plurality of stages for the business process for which workflow 16 is to be created. The business process may be complex or simple, but in any case, is a discrete undertaking that includes a set of high level requirements for its completion. The business process, may be an internal undertaking or, in the alternative, may include elements to be performed for and/or at the behest of another, such as a customer. In any case, the stages defined by stage definer 42 constitute discrete portions of the overall business process, each satisfying one or more goals and having one or more related activities. Information used by stage definer 42 may be gathered, such as from a customer, in any manner that is now known or later developed.

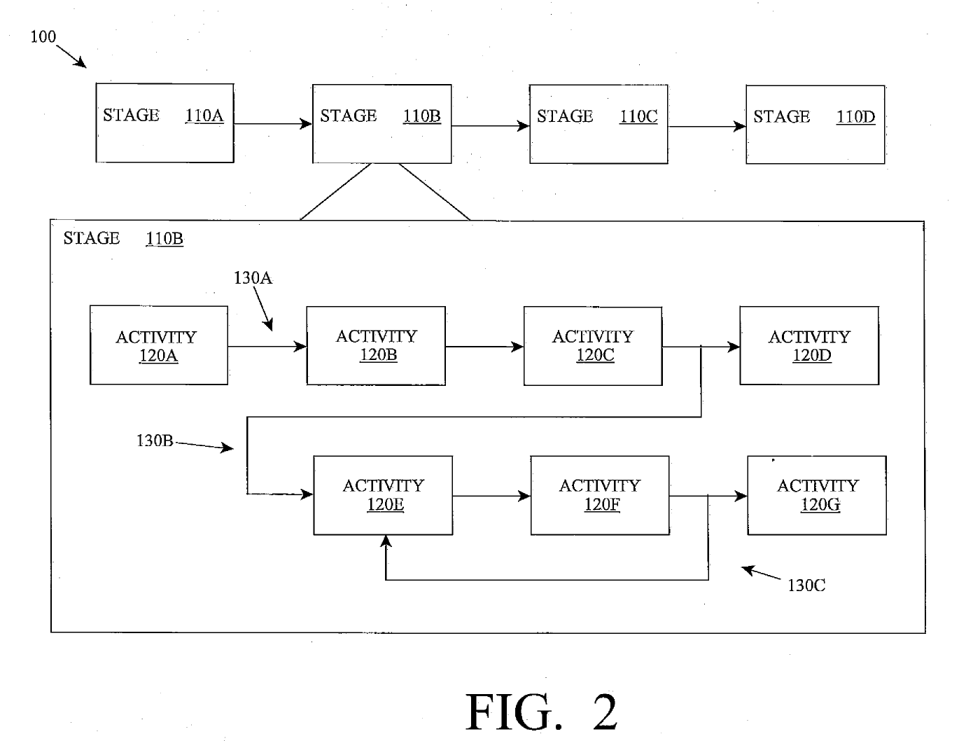

Referring now to FIGS. 1 and 2 concurrently, a workflow 100 is shown. Workflow 100 has a plurality of stages 110A-D. As stated above, workflow 100 is divided into several stages 110A-D that include one or more related activities using stage definer 42. For example, if workflow 100 defines the business process of setting up an automatic teller machine (ATM), stage 110A may include one or more activities for obtaining permits, stage 110B may include one or more activities for physically installing the ATM, stage 110C may include one or more activities for installing the software for the ATM, and stage 110D may include one or more activities for connecting the ATM to a network. As further shown in the figure, at least one stage 110B of the plurality of stages 110A-D has more than one of activity 120A-G.

Stage Activity Lister 44 enables user 16 to compile a list of activities 120A-G that make up stage 110B having more than one activity 120A-G. Each activity 120A-G specifies a discrete subset of stage 110B that may be required for stage 110B to be completed successfully. Stage activity lister 44 also enables user 16 to define any flow and/or dependencies 130A-C among various ones of the activities 120A-G. As shown, flow and/or dependencies 130A-C may include a simple linear progression 130A from one activity (e.g., 120A) to another (e.g., 120B); a branch 130B to one or more of two or more activities that may or may not be dependent upon some condition having been met; a loop 130C that may or may not be dependent upon some condition having been met; and/or any flow and/or dependency construct now known or later developed.

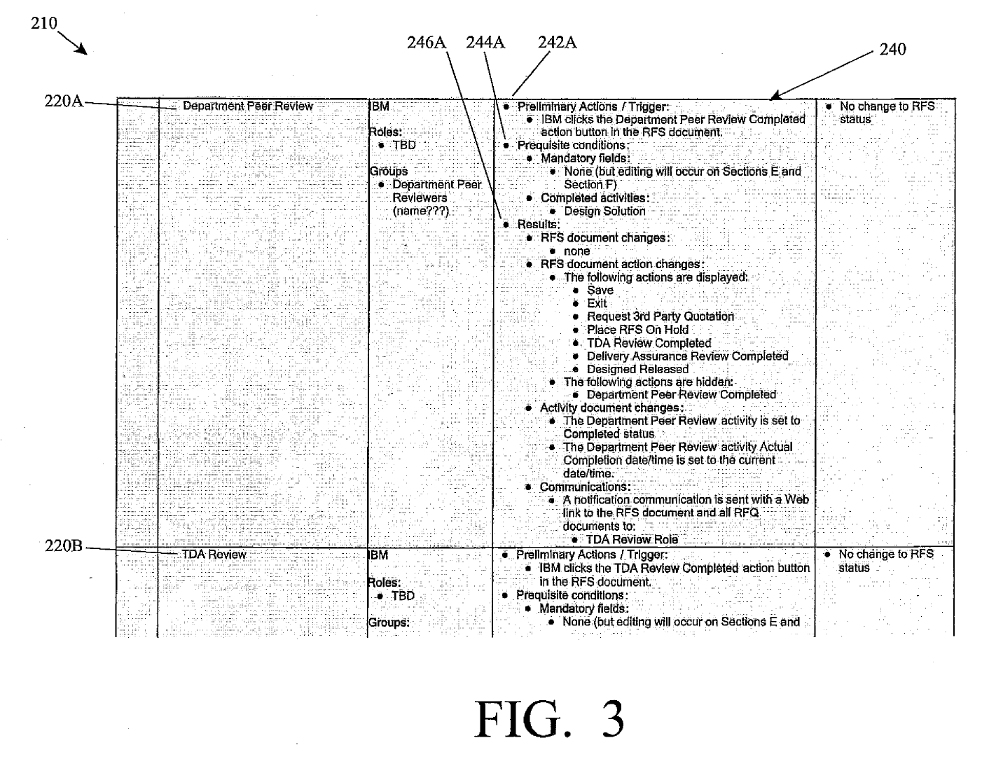

Referring now to FIGS. 1 and 3, concurrently, operational detail definer 46 allows a set of one or more operational details 240 to be defined for each activity 220A-B. FIG. 3 shows a portion of stage 210 having at least two activities 220A-B. Operational details 240 may be classified as, for example, preliminary actions/trigger 242A, which indicate the goal and/or goals that must be accomplished in order for activity 220A to be complete. Operational details 240 may also be classified as prerequisite conditions 244A, which indicate conditions that are necessary for completion of the goal indicated by preliminary actions/trigger 242A. Prerequisite conditions may include one or more of mandatory fields, completed activities, approvals received, data elements from external documents, and/or the like. Still further, operational details 240 may be classified as results 246A that are generated based on the completion activity 220A. To this extent, results 246A may include one or more of changes to a document data element, changes to a document control, status changes to the current activity and/or another activity, data transfer, communications, and/or the like.

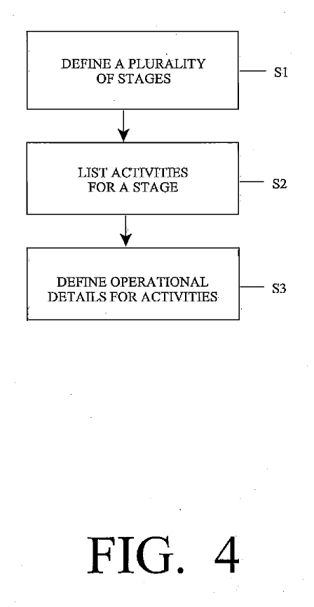

Turning now to FIG. 4, a flow chart of a method according to an embodiment of the present invention is depicted, which is described with reference to FIG. 1. In process S1, stage definer 42 is used to define a plurality of stages 110A-D (FIG. 2) for a particular activity 100. Stages 110A-D may be defined from overall high level goals of business process 100 and have one or more related activities, with at least one stage 110B having multiple activities 120A-G. In process S2, stage activity lister 44 allows activities 120A-G and flow and/or dependencies 130A-C to be listed for a stage 110B that has multiple activities 120A-G. In process S3, operational detail definer 46 allows operational details 240 (FIG. 3) to be defined for each activity 220A-B.

While shown and described herein as a method and system for creating a workflow that defines a business process, it is understood that the invention further provides various alternative embodiments. For example, in one embodiment, the invention provides a computer-readable/useable medium that includes computer program code to enable a computer infrastructure to create a workflow that defines a business process. To this extent, the computer-readable/useable medium includes program code that implements the process of the invention. It is understood that the terms computer-readable medium or computer useable medium comprises one or more of any type of tangible embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 22 (FIG. 1) and/or storage system 30 (FIG. 1) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process of the invention on a subscription, advertising, and/or fee basis. That is, a service provider, such as a Solution Integrator, could offer a service for creating a workflow that defines a business process. In this case, the service provider can create, maintain, support, etc., a computer infrastructure, such as computer infrastructure 12 (FIG. 1) that performs the process of the invention for one or more entities. In return, the service provider can receive payment from the entity(s) under a subscription and/or fee agreement and/or the service provider can receive payment from the sale of advertising content to one or more third parties.

In still another embodiment, the invention provides a computer-implemented method for creating a workflow that defines a business process. In this case, a computer infrastructure, such as computer infrastructure 12 (FIG. 1), can be provided and one or more systems for performing the process of the invention can be obtained (e.g., created, purchased, used, modified, etc.) and deployed to the computer infrastructure. To this extent, the deployment of a system can comprise one or more of (1) installing program code on a computing device, such as computer system 14 (FIG. 1), from a computer-readable medium; (2) adding one or more computing devices to the computer infrastructure; and (3) incorporating and/or modifying one or more existing systems of the computer infrastructure to enable the computer infrastructure to perform the process of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A method for creating a workflow that defines a business process, comprising:
defining a plurality of stages, at least one stage of the plurality of stages comprising a plurality of activities that are logically related;
listing, for the stage, the activities that comprise the stage and the flow between the activities, and
defining, for each activity of the activities, a set of operational details that the activity includes.

2. The method of claim 1, wherein the business process is a complex business process.

3. The method of claim 1, wherein the operational details include at least one of preliminary actions, prerequisite conditions, and results.

4. The method of claim 1, wherein the operational details include preliminary actions that trigger a completion of the activity.

5. The method of claim 3, wherein the operational details include prerequisite conditions and wherein the prerequisite conditions include at least one of mandatory fields, completed activities, approvals received, or data elements from external documents.

6. The method of claim 3, wherein the operational details include results and wherein the results include changes to a document data element, changes to a document control, status changes, data transfer, and communications.

7. A system for creating a workflow that defines a business process, comprising:
a stage definer for defining a plurality of stages, at least one stage of the plurality of stages comprising a plurality of activities that are logically related;
a stage activity lister for listing, for the stage, the activities that comprise the stage and the flow between the activities, and
an operational detail definer for defining, for each activity of the activities, a set of operational details that the activity includes.

8. The system of claim 7, wherein the business process is a complex business process.

9. The system of claim 7, wherein the operational details include at least one of preliminary actions, prerequisite conditions, and results.

10. The system of claim 7, wherein the operational details include preliminary actions that trigger a completion of the activity.

11. The system of claim 7, wherein the operational details include prerequisite conditions and wherein the prerequisite conditions include at least one of mandatory fields, completed activities, approvals received, or data elements from external documents.

12. The system of claim 7, wherein the operational details include results and wherein the results include changes to a document data element, changes to a document control, status changes, data transfer, and communications.

13. A program product stored on a computer readable medium for creating a workflow that defines a business process, the computer readable medium comprising:
program code for defining a plurality of stages, at least one stage of the plurality of stages comprising a plurality of activities that are logically related;
program code for listing, for the stage, the activities that comprise the stage and the flow between the activities, and
program code for defining, for each activity of the activities, a set of operational details that the activity includes.

14. The program product of claim 13, wherein the business process is a complex business process.

15. The program product of claim 13, wherein the operational details include at least one of preliminary actions, prerequisite conditions, and results.

16. The program product of claim 13, wherein the multiple document interface environment is a web browser.

17. The program product of claim 13, wherein the operational details include prerequisite conditions and wherein the prerequisite conditions include at least one of mandatory fields, completed activities, approvals received, or data elements from external documents.

18. The program product of claim 13, wherein the operational details include results and wherein the results include changes to a document data element, changes to a document control, status changes, data transfer, and communications.

19. A method for creating a workflow that defines a business process, comprising:
providing a computer infrastructure being operable to:
define a plurality of stages, at least one stage of the plurality of stages comprising a plurality of activities that are logically related;
list, for the stage, the activities that comprise the stage and the flow between the activities, and
define, for each activity of the activities, a set of operational details that the activity includes.

20. The method of claim 19, wherein the operational details include at least one of preliminary actions, prerequisite conditions, and results.
